(19) United States
(12) Patent Application Publication
(10) Pub. No.: US 2020/0157875 A1
(43) Pub. Date: May 21, 2020

(54) System and Method to Remotely Operate a Door

(71) Applicants: Dana L. Jones, Poughkeepsie, NY (US); Jacob A. Ernst, Broadalbin, NY (US)

(72) Inventors: Dana L. Jones, Poughkeepsie, NY (US); Jacob A. Ernst, Broadalbin, NY (US)

(73) Assignee: Accessadoor, LLC, Poughkeepsie, NY (US)

(21) Appl. No.: 16/428,978

(22) Filed: Jun. 1, 2019

Related U.S. Application Data
(60) Provisional application No. 62/679,176, filed on Jun. 1, 2018.

(51) Int. Cl. E05F 15/76; E05F 15/77; G08C 17/02; E05F 15/73

(52) U.S. Cl. CPC E05F 15/76; E05F 15/77; G08C 2201/93; E05F 2015/763; G08C 17/02

(57) ABSTRACT

A system and method to remotely operate a door, the method including: transmitting a door's proximity to a mobile device; receiving, by the mobile device, identifying information from a remote intermediary processing server; receiving, from a user, a command to operate the door; and transmitting the command to operate the door.

### CROSS-REFERENCE TO RELATED APPLICATIONS

This Application claims the benefit of U.S. Provisional Patent Application Ser. No. 62/679,176, filed on Jun. 1, 2018, incorporated herein in its entirety by reference.

### STATEMENT REGARDING FEDERALLY-SPONSORED RESEARCH OR DEVELOPMENT

Not Applicable.

### FIELD OF THE INVENTION

The present invention is directed to a system and method to wirelessly operate an automatic door without requiring network connectivity to said door.

### BACKGROUND OF THE INVENTION

Access to public and private spaces by those differently-abled is becoming more widespread. According to the U.S. Census, 36.6 million Americans have mobility impairment, for example requiring the use of wheelchairs or walkers. Previously, many public spaces such as municipal buildings, museums, and gathering places did not have accommodations to permit a person confined to a wheelchair, using crutches or a walker, traveling with a service animal, or otherwise unable to perambulate independently to enter without climbing stairs. The Americans with Disabilities Act was promulgated in 1990 and amended in 2008 to require accommodations be made to permit differently-abled individuals to enter public spaces. One common accommodation is a button placed near the entrance to a building that triggers a device to open the door without requiring the user to pull and hold the often-heavy door. Although automatic doors increase accessibility, they are not required by the ADA regulations.

The proliferation of these trigger buttons is widespread. However, retrofitting a building with trigger buttons and ramps does not always create equal access to the building. Frequently, the trigger buttons are located away from a main entrance or are installed in a place that is also hard to access, such as too high up or many feet away from the door it activates. At times, it can be confusing to the user which trigger button will give them access to their intended destination, because the ADA-compliant ramps lead away from the main entrance of a building.

Of particular interest is the lack of a means in the art to operate these trigger buttons without tactile pressure. Ambulatory disabilities are only one of the limitations to access, and many medical conditions create either a temporary or permanent inability or a user to use their hand or arms at all.

Further, there is no limit on the number of users of a given trigger button, and they become germ-infested and are rarely cleaned. Therefore, they are an unsafe method for a user who is immune-suppressed to access a building, because touching the trigger button will force exposure to many germs.

Without redesigning older buildings around optimal access, the fact remains that trigger buttons and the doors they operate will be secondary to the main entrance to many buildings for some time to come. There currently is not a known method to permit a user to learn where they are entering the building in the event they do not enter through the main entrance due to accessibility issues. The present invention provides information about the door and building to the user, empowering the user to navigate independently and without touching the trigger button or needing to ask for directions.

In their current implementation, these retrofitted trigger buttons may either be battery-powered or hard-wired into the building's power source. When the trigger buttons are battery-powered, they are more prone to lose charge unnoticed by abled users who do not need the trigger button to enter the building, leaving them inoperable for differently-abled users. The present invention will alert a manager that a trigger button is inoperable and offer suggested alternatives for access. It will further offer a building monitor usage and battery life statistics to maximize accommodations for the public.

When the trigger buttons are hard-wired after construction, they are less likely to be easily reachable by a differently-abled user, as they are installed for the convenience of the electrician rather than the user. ADA guidelines are directed to the height of the trigger button only, not its proximity to the door itself.

Portable applications which allow remote operation of electronic devices are known in the art. One disadvantage of existing technology is the app is constantly running in the background of the mobile device operating system, including radio noise, reducing battery life, and potentially creating a security liability. Likewise, the installation will be prone to false triggers. In the event of a paired interior and exterior vestibule door, when they are both open at the same time, it causes a strain the HVAC system. These teach away from the present invention because they require the user to maintain an account and/or install electronic devices themselves, something which is impossible for each user to do in public spaces.

There is a need in the marketplace to accommodate remote access to ADA-compliant trigger buttons. Current commercial embodiments of portable applications are not programmable to be used widely and in public spaces. The present invention meets an unmet need in the market by enabling any user with a portable application installed on their mobile device to operate a compatible door trigger button without requiring them to touch it.

### SUMMARY OF THE INVENTION

The present invention resides in one aspect in a system and method to remotely operate a door, the method including identifying a door's proximity to a mobile device; receiving, by the mobile device, identifying information from a remote intermediary processing server (“RIPS”); receiving, from a user, a command to operate the door; and transmitting the command to operate the door. In one embodiment, the system provides remote operability of a door by a user, the system comprising: a transmitter in communication with a door operating apparatus; a mobile transmitter in communication with a remote intermediary processing server; a receiver in communication with the door operating apparatus; a mobile receiver in communication with the RIPS configured to receive a unique hardware identifier; a mobile device application; and a communication interface configured to: exchange a packet between the door operating apparatus and the RIPS; to exchange a packet between the RIPS and a mobile device; to identify proximity to the door operating apparatus; to transmit, from the RIPS, a request to the mobile device to initiate a response; to receive, from the mobile device, a response to said request; and, if the response is affirmative, a command to the door operating apparatus to initiate the door operating apparatus.

These and other aspects of the present invention will become apparent to those skilled in the art after a reading of the following description of the preferred embodiment when considered with the drawings.

### BRIEF DESCRIPTION OF THE DRAWINGS

The above and still further features and advantages of the present invention will become apparent upon consideration of the following detailed description of embodiments thereof, especially when taken in conjunction with the accompanying drawings wherein like reference numerals in the various figures are utilized to designate like components, and wherein:

FIG. 1 is a schematic view of the present invention;

FIGS. 2A and B are alternative embodiments of the present invention, FIG. 2A depicting a door cluster and FIG. 2B depicting a door group;

FIG. 3 is a block diagram depicting a user interface portion of a mobile communication network in accordance with an embodiment of the present invention;

FIG. 4 is a block diagram depicting a loop process of the mobile communication network;

FIGS. 5A and 5B are diagrams of a transceiver in accordance with an embodiment of the present invention; and

FIG. 6 is a block diagram depicting a process to determine a mobile device's proximity to a transmitter.

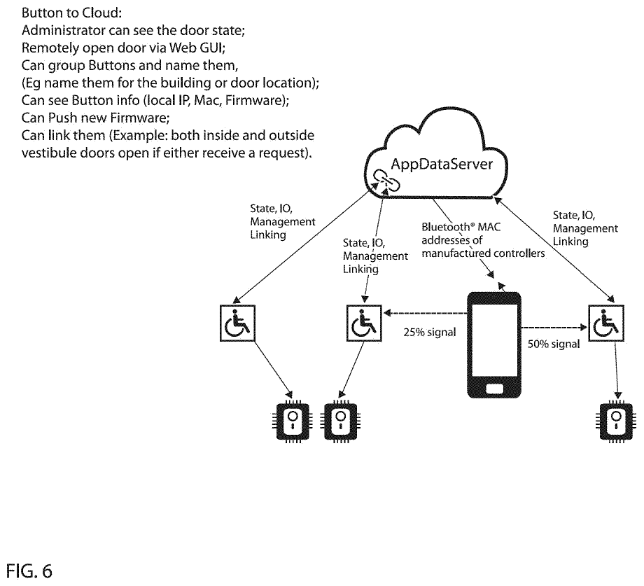

### DETAILED DESCRIPTION

As used herein, the term “transmitter” may generally comprise any device, circuit, or apparatus capable of transmitting a signal. As used herein, the term “receiver” may generally comprise any device, circuit, or apparatus capable of receiving a signal. As used herein, the term “transceiver” may generally comprise any device, circuit, or apparatus capable of transmitting and receiving a signal. As used herein, the term “signal” may include one or more of an electrical signal, a radio signal, an optical signal, an acoustic signal, and so forth.

As used herein, the term “module” refers generally to a logical sequence or association of steps, processes or components. For example, a software module may comprise a set of associated routines or subroutines within a computer program. Alternatively, a module may comprise a substantially self-contained hardware device. A module may also comprise a logical set of processes irrespective of any software or hardware implementation

Embodiments in accordance with the present disclosure improve upon the known art by performing a remotely operating a door apparatus at a user's command on a wireless device via a remote intermediary processing server (“RIPS”) without necessitating that the user's wireless device connect with the door.

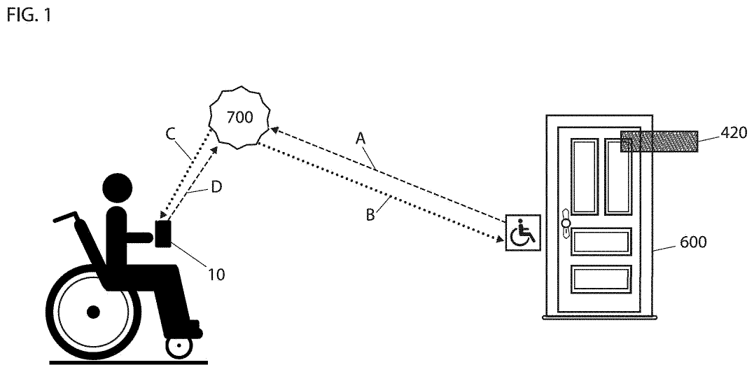

As shown in FIG. 1, a portable application 100 may be installed on any device 10 with wireless transmission capabilities, such as, for example, a smartphone or smartwatch.

As shown in FIG. 1, the portable application 100 connects via a wireless transmitter 120 and a wireless receiver 140 with a remote intermediary processing server (“RIPS”) 700, as shown by Lines C and D. The RIPS 700 further connects to a transceiver 410. The RIPS 700 is in ongoing looped communication with an activation device 400 by means of the transceiver 410, indicated by Lines A and B.

As shown in FIG. 1, the activation device 400 further has a network interface card 310 that transmits a media access control (“MAC”) address, such as, for example a BlueTooth® connectivity signal.

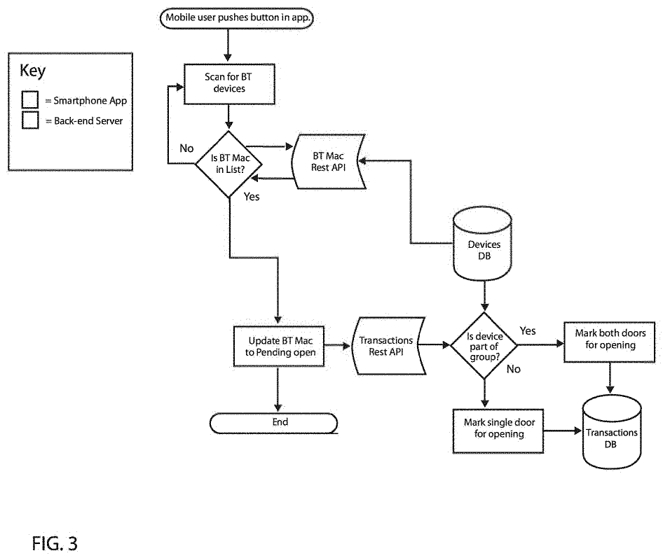

The portable application 100 runs a module 110. As shown in FIG. 3, when a user intends to open the door 600, the user operates a user interface 130 on the mobile device 10. In another embodiment, the user interface 130 is operable by the user's voice or other sound. The module 110 then scans for a nearby activation device 400, the activation device 400 having, in one embodiment, a Bluetooth connection to the RIPS 700. The module 110 downloads a list of known activation devices 400 devices from the RIPS 700. If the address identified by the module 110 during the scan matches any value from the RIPS 700, then the module 110 informs the RIPS 700 it would like the known device to open.

In one embodiment, a touchscreen user interface (“tGUI”) appears on the screen of the user's mobile device. The tGUI indicates that a door is available to open as the user approaches the door. The user may interact with the tGUI to indicate that the door should be open, for example, by touching a tGUI command labeled “Open” on the user interface 130.

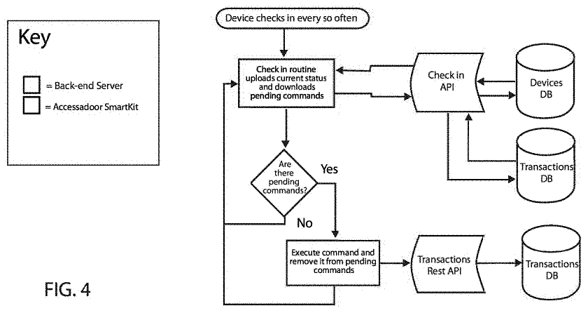

The activation device 400 has an operating module 420. As shown in FIG. 4, the operating module 420 is in a constant communication loop with the RIPS 700 with various data. The operating module 420 asks the RIPS 700 if it has any pending actions every time the operating module 420 checks in. In the event the user has sent the command to open the door, the RIPS 700 indicates to the operating module 420 that there is a pending action. When the operating module 420 checks in with the RIPS 700 and there is a pending action, the operating module 420 executes the action, that is, causes the door to open by a door operating apparatus 200. The operating module 420 then informs the RIPS 700 it has completed the action and to remove it from pending. It is at this point the operating module 420 returns to periodic checking in waiting for pending actions. The user-initiated signal, for example, triggers the door operating apparatus 200 to cause the door to open.

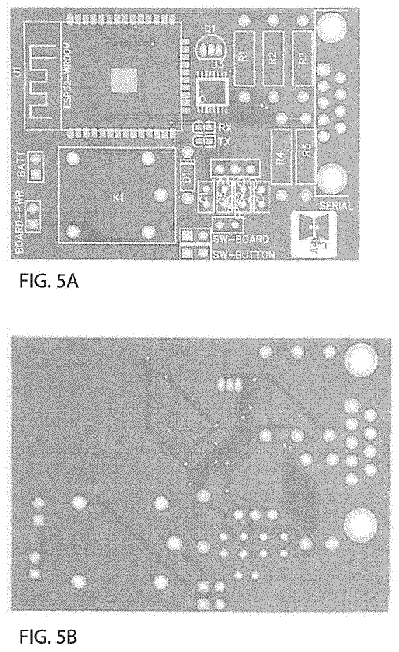

As shown in FIG. 5B, in one embodiment of the present invention, a plurality of doors 600 is assigned to the group 610 by a manager via the manager interface 900. The RIPS 700 checks whether the known activation device 400 is part of a group 610. If the activation device 400 is a part of a group 610, then the RIPS 700 also marks the other grouped doors 600 for opening. The RIPS 700 compares the time-to-report and signal strength data from the module 110 to determine which of the grouped doors 611B or 612B is the closer to the user and therefore which should be opened sooner.

As shown in FIG. 5A, in another embodiment of the present invention, a plurality of doors 600 are not grouped, however they are proximate such that the module 110 must determine which of the plurality of doors 600 to open. The module 110 scans for a nearby activation device 400. The module 110 downloads a list of known activation devices 400 devices from the RIPS 700. In the event there is more than one activation device 400 nearby, the module 110 compares all scanned activation devices 400 against the list downloaded from the RIPS 700. In one embodiment, RIPS 700 compares the time-to-report and signal strength data from the module 110 to determine which of the grouped doors 611A or 612A is the closer to the user and therefore which should be opened sooner. In another embodiment, the RIPS 700 transmits both activation devices 400 to the module 110 and the user interface 130 presents the user with an option of which activation device 400 to activate. The module 110 informs the RIPS 700 that it would like the closest address identified by the module 110 during the scan to open.

As show in FIG. 7, a user may access the user interface 130 set to their language and sightedness capacity. In one embodiment, the user interface 130 is via a screen 131. In another embodiment, the user interface 130 is a voice interface 139 such as a sound-activated speaker. In one embodiment, the user of the portable application 100 may cause the wireless transmitter 120 to send the signal. In another embodiment, the wireless transmitter 120 broadcasts the signal to the transceiver 410 without user activity.

In one embodiment, the RIPS 700 receives and records information from a plurality of activation devices 400 such as, for example, number of times a door has been opened, times of day of most use, and how each of the doors 600 was triggered. A manager may interface with the RIPS 700 by a management interface 710 to access information about the usage of any one of a plurality of doors 600 in an installation 800.

In one embodiment, the activation device 400 is powered by a battery 500. A battery sensor 520 is in communication with the activation device 400. Information about the life of the battery 500 is transmitted to the RIPS 700. In one embodiment, the management interface 710 requests information from RIPS 700 regarding battery life of the battery 500. In another embodiment, information about battery life of the battery 500 is pushed to the management interface 710 by the RIPS 700.

In another embodiment, the command to open the door may be a voice command, bypassing the user's need to operate either the trigger button or the mobile devise by touch.

In one embodiment, an installation 800 includes a plurality of doors 600 may be located close to one another and each within the range of the wireless transmitter 120. The installation 800 may include in one embodiment a plurality of doors 600 in a single structure 810. In another embodiment, the installation 800 may include a plurality of structures 810 each outfitted with one or more doors 600, such as, for example, an exterior access and a restroom. The RIPS 700 is in communication with all doors 600 in the installation 800 and further sends information to the management interface 710.

In one embodiment, the RIPS 700 can identify and respond to individual portable applications 100 in a customizable way. In another embodiment, the user can input preferences into the portable application 100 by means of the user interface 130.

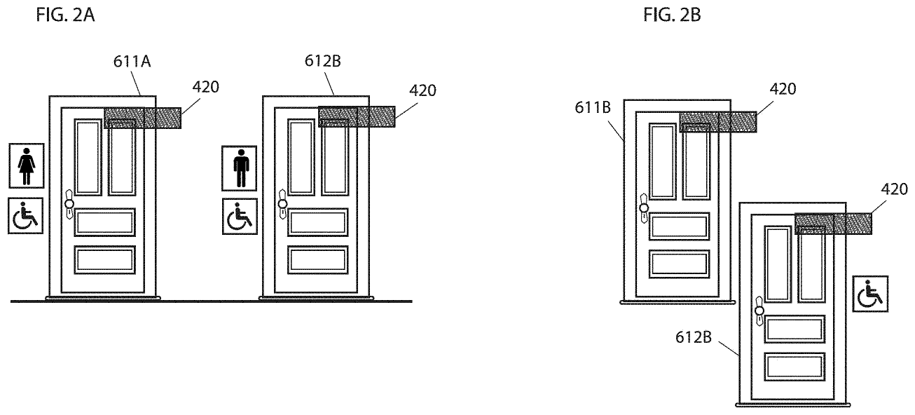

In one embodiment, a plurality of doors 600 are installed close together such that the portable application 100 could be in wireless communication with each of the plurality of doors 600 simultaneously. As shown in FIG. 4A, in one embodiment, a single activation of the portable application 100 by the user causes each of the doors to open in a pre-programmed staggered sequence. As shown in FIG. 2B, for example, door 611B and door 612B are two portions of a vestibule to enter a building from the outside. It is understood that the energy-saving benefits of a vestibule become moot if both the interior and exterior vestibule doors are open for an extended period of time. In another embodiment, the user may select which one of a plurality of doors 600 to open. As shown in FIG. 2A, for example, the user will choose to access only one of either door 611A or door 612A despite their proximity. In another embodiment, there are multiple nonconsecutive doors 600 and the system identifies the closest door to the user to open.

In one embodiment, the user interface 130 provides specific information to the user regarding, for example, to which building of an installation 800 the door 600 provides access and other information about the location, such as for example, which floor the user is about to enter and what points of interest are inside.

In one embodiment, the management interface 710 programs functions executed by the RIPS 700, such as, for example, grouping a plurality of activation devices 400. In another embodiment, the management interface 710 causes the RIPS 700 to execute functions such as, for example, remotely opening the door 600. In another embodiment, the management interface 710 can push firmware to the RIPS 700.

It is understood that in other embodiments of the present invention the arrangement of doors 600 may be any combination of the types described above. It is understood that in other embodiments of the present invention, the user interface 130 can be any of a plurality of devices, such as for example, a smartphone, a watch or other wearable device, or an independent device. It is understood that in other embodiments of the present invention, the ease of a user access

A number of embodiments of the invention have been described. Nevertheless, it will be understood that various modifications may be made without departing from the spirit and scope of the invention. Accordingly, other embodiments are within the scope of the following claims.

What is claimed is:

1. A method to remotely operate a door, the method comprising:
identifying a mobile device's proximity to a door;
receiving, by the mobile device, identifying information from a remote intermediary processing server;
receiving, from a user, a command to operate the door; and
transmitting the command to operate the door.

2. The method of claim 1 wherein the door is operated by a motor.

3. The method of claim 2 wherein the command activates the motor.

4. The method of claim 1, the method further comprising receiving, from a user, a command to operate the door wherein the command is a voice command.

5. The method of claim 1, the method further comprising receiving and storing information on usage of the door.

6. The method of claim 5, the method further comprising providing the usage information to a management interface.

7. The method of claim 5, the method further comprising providing information on the battery life of a connected battery to the management interface.

8. The method of claim 1, the method further comprising collecting and storing usage information for the door.

9. The method of claim 1, the method further comprising receiving, from a user, a command to operate the door by means of a touchscreen user interface (“tGUI”).

10. A system to provide remote operability of a door by a user, the system comprising:
a transmitter in communication with a door operating apparatus;
a mobile transmitter in communication with a remote intermediary processing server;
a receiver in communication with the door operating apparatus;
a mobile receiver in communication with the remote intermediary processing server configured to receive a unique hardware identifier;
a mobile device application; and
a communication interface configured: to exchange a packet between the door operating apparatus and the remote intermediary processing server; to exchange a packet between the remote intermediary processing server and a mobile device;
to identify proximity to the door operating apparatus; to transmit, from the remote intermediary processing server, a request to the mobile device to initiate a response; to receive, from the mobile device, a response to said request; and, if the response is affirmative, a command to the door operating apparatus to initiate the door operating apparatus.

11. The system of claim 10, the system further comprising a management interface in communication with the remote intermediary processing server.

12. The system of claim 11 wherein the communication interface is further configured to exchange usage information with the management interface.

13. The system of claim 12 wherein the management interface is in communication with a plurality of doors.

14. The system of claim 13 wherein the management interface is customizable by an operator to record and store usage data of any one of the plurality of doors.

15. The system of claim 14 wherein the usage information for the plurality of doors is presented in real time to an operator interface.

16. The system of claim 10 further comprising a data processing system configured to:
identify multiple proximate doors, determine which door is the closest to the user, and cause only the closest door to open.

17. The system of claim 10 further comprising a data processing system configured to open a plurality of operator-connected doors after a single response from the mobile device.

18. The system of claim 17 wherein the data processing system is further configured to:
determine which one of a plurality of operator-connected doors is closest to the receiver in the mobile device, and open the operator-connected door closest to the receiver in the mobile device first in the sequence of opening the plurality of operator-connected doors.

19. The system of claim 17 wherein the data processing system is further configured to:
determine which one of a plurality of doors is closest to the receiver in the mobile device, and initiate only the operating system of the door closest to the receiver in the mobile device.

20. The system of claim 10 further comprising a WiFi connection to any one of a number of WiFi-enabled electronic devices.

21. The system of claim 10 further comprising a Bluetooth® radio connecting to any one of a plurality of Bluetooth®-enabled electronic devices.

22. The system of claim 10 wherein the door operating apparatus has a battery.

23. The system of claim 10 wherein the communication interface is further configured to provide information about the operating system to the mobile device.

24. The system of claim 10, the system further comprising a voice recognition module.

25. The system of claim 10, the system further comprising a touch screen user interface (“tGUI”) configured to: indicate that the door is proximate, indicate that the door is operable by the command, receive the command from the user, and transmit the command.

26. The system of claim 10, the system further comprising a data storage unit configured to retain and transmit unique information about the door.
